(19) United States
(12) Patent Application Publication
(10) Pub. No.: US 2025/0162683 A1
(43) Pub. Date: May 22, 2025

(54) Twistgrip Steering For Hand Powered Vehicles

(71) Applicant: Kent A. Nywall, Fort Collins, CO (US)

(72) Inventor: Kent A. Nywall, Fort Collins, CO (US)

(21) Appl. No.: 18/513,936

(22) Filed: Nov. 20, 2023

(51) Int. Cl. B62M 1/12; B62K 19/32; B62K 21/18; B62K 23/04; B62M 1/36; B62M 9/02

(52) U.S. Cl. CPC B62M 1/12; B62K 19/32; B62K 21/18; B62K 23/04; B62M 1/36; B62M 9/02

(57) ABSTRACT

A steering system and/or a driving system and/or a vehicle including one or more thereof, whereby the driving system can include a drivable wheel coupled to a frame of the vehicle and actuated by a driving actuator, and the steering system can include a steerable wheel coupled to the frame of the vehicle and actuated by a steering actuator. The vehicle can be configured as a human-powered vehicle, which may be similar to a bicycle, tricycle, quadricycle, wheelchair, or the like.

### I. SUMMARY OF THE INVENTION

A broad object of a particular embodiment of the invention can be to provide a steering system and/or a driving system and/or a vehicle including one or more thereof, whereby the driving system can include a drivable wheel coupled to a frame of the vehicle and actuated by a driving actuator, and the steering system can include a steerable wheel coupled to the frame of the vehicle and actuated by a steering actuator. The vehicle can be configured as a human-powered vehicle, which may be similar to a bicycle, tricycle, quadricycle, wheelchair, or the like.

Naturally, further objects of the invention are disclosed throughout other areas of the specification, drawings, and claims.

### II. BRIEF DESCRIPTION OF THE DRAWINGS

FIG. 1A is a perspective view of a particular embodiment of the inventive vehicle configured as a quadricycle.

FIG. 1B is a left side view of the particular embodiment of the vehicle shown in FIG. 1A.

FIG. 1C is a front view of the particular embodiment of the vehicle shown in FIG. 1A.

FIG. 1D is a rear view of the particular embodiment of the vehicle shown in FIG. 1A.

FIG. 1E is a top view of the particular embodiment of the vehicle shown in FIG. 1A.

FIG. 2A is a perspective view of a particular embodiment of the inventive vehicle configured as a bicycle.

FIG. 2B is a left side view of the particular embodiment of the vehicle shown in FIG. 2A.

FIG. 2C is a front view of the particular embodiment of the vehicle shown in FIG. 2A.

FIG. 2D is a rear view of the particular embodiment of the vehicle shown in FIG. 2A.

FIG. 2E is a top view of the particular embodiment of the vehicle shown in FIG. 2A.

FIG. 3 is a perspective view of a particular embodiment of the inventive steering system.

FIG. 4A is a perspective view of a particular embodiment of a handle of the present invention.

FIG. 4B is an exploded view of the particular embodiment of the handle shown in FIG. 4A.

FIG. 5A is a perspective view of a particular embodiment of a handle of the present invention.

FIG. 5B is an exploded view of the particular embodiment of the handle shown in FIG. 5A.

FIG. 6A is a front perspective view of a particular embodiment of a fork of the inventive steering system.

FIG. 6B is a rear perspective view of the particular embodiment of the fork shown in FIG. 6A.

### III. DETAILED DESCRIPTION OF THE PREFERRED EMBODIMENTS

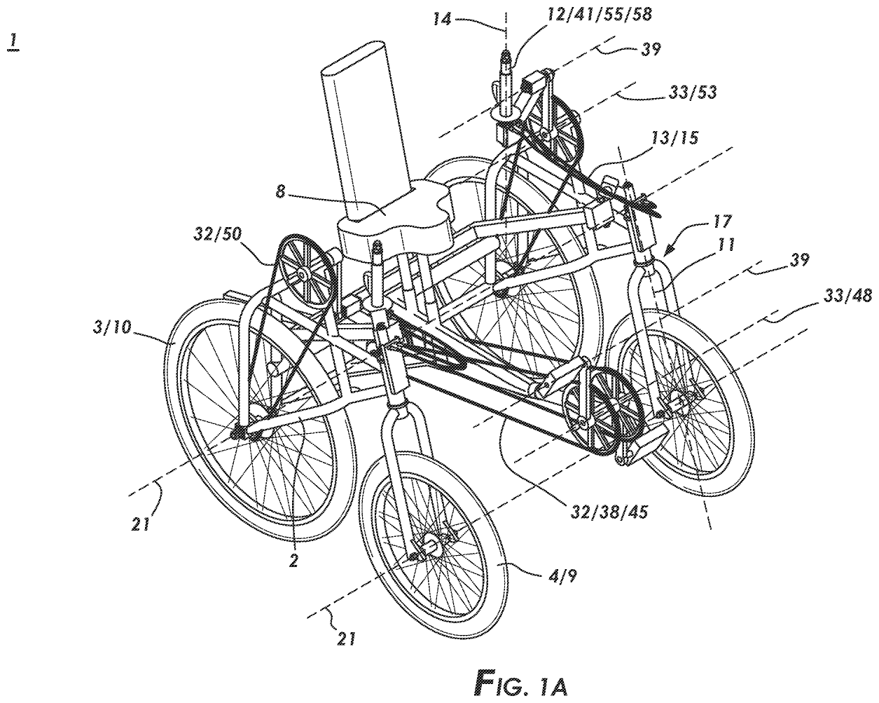

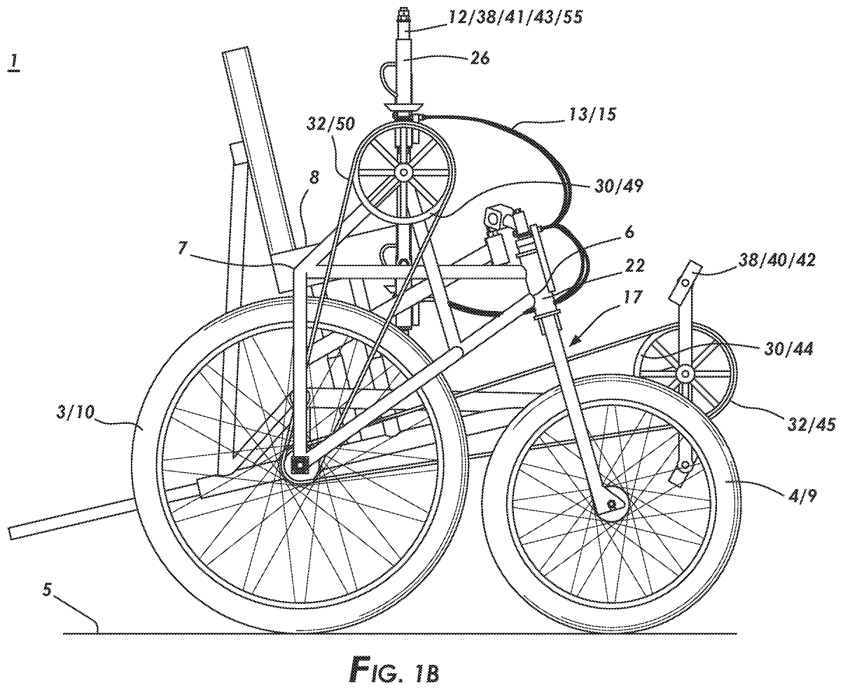

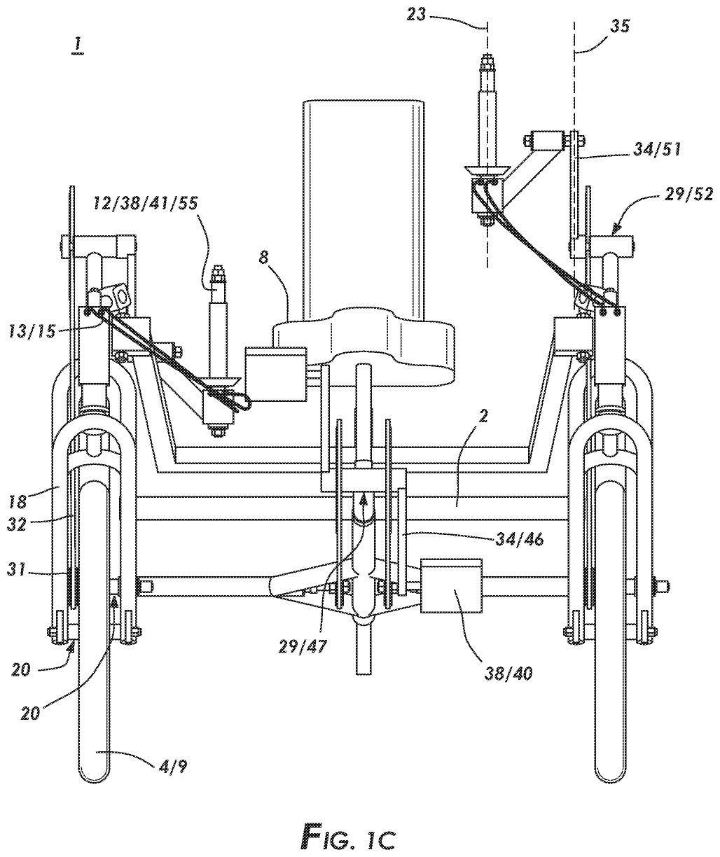

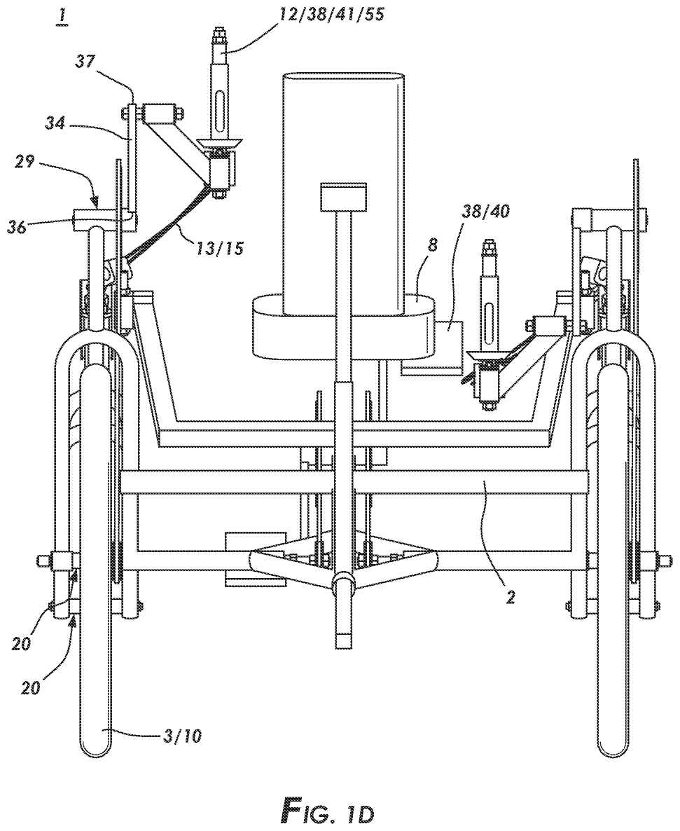

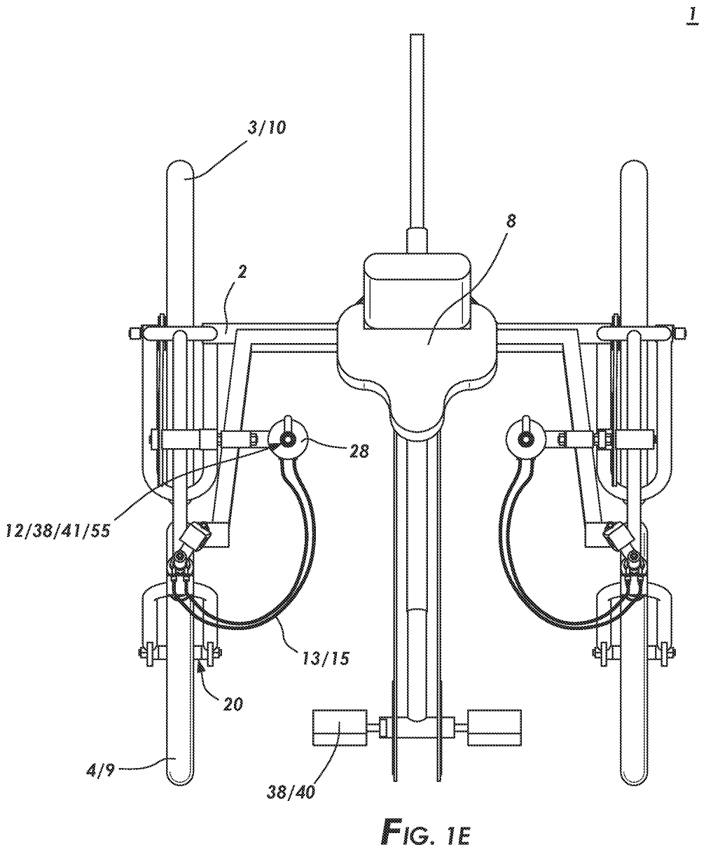

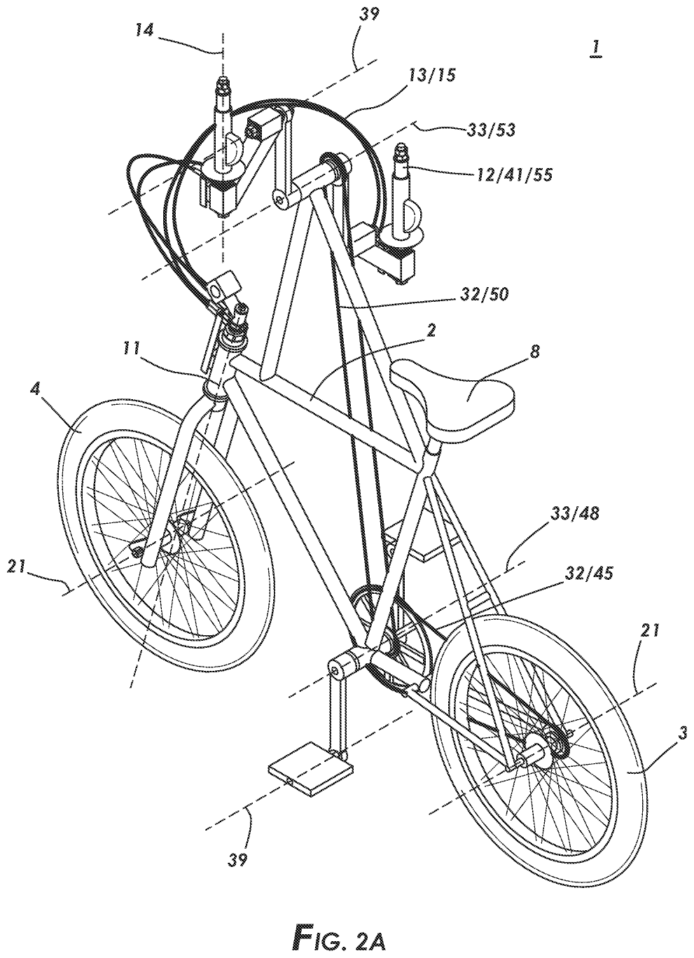

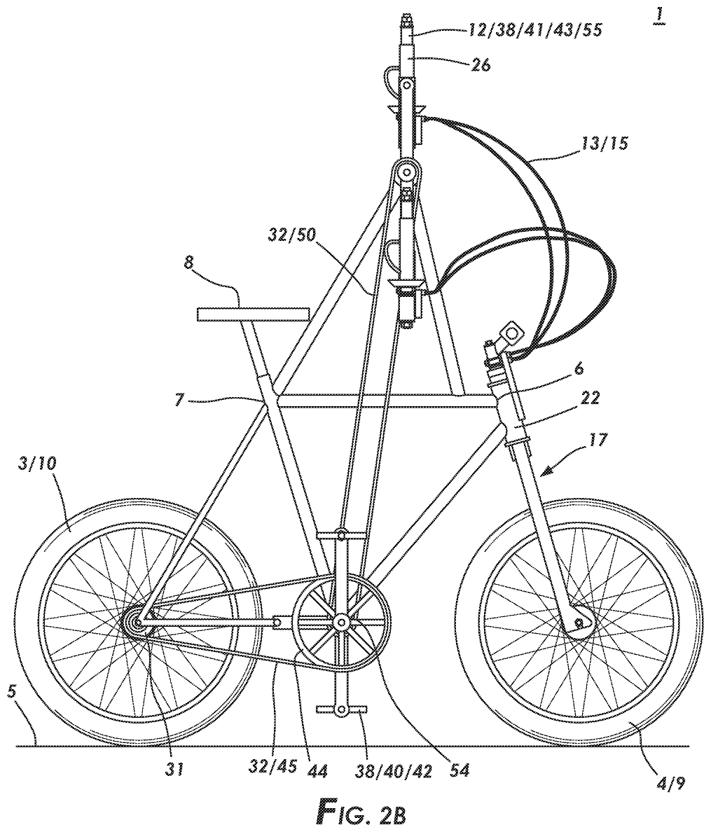

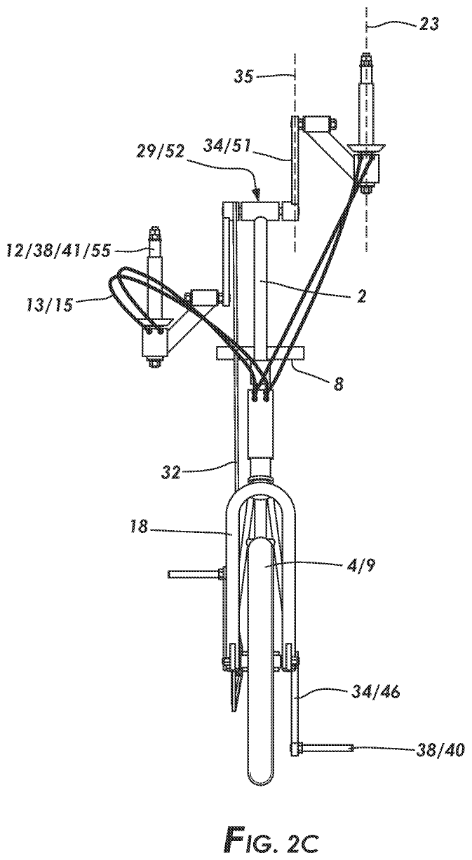

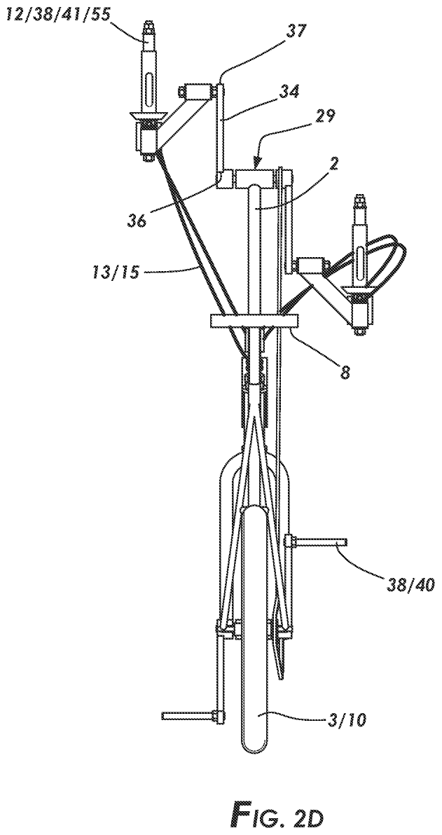

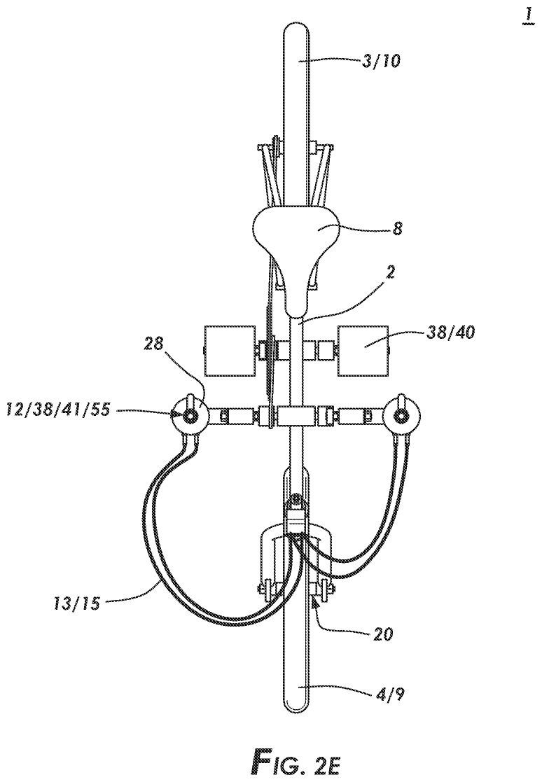

Now referring primarily to FIGS. 1A through 1E and 2A through 2E, two particular embodiments of the inventive vehicle (1) are shown, whereby the vehicle (1) comprises a frame (2), a driving system including a drivable wheel (3) coupled to the frame (2), and a steering system including a steerable wheel (4) coupled to the frame (2). The vehicle (1) can have any of a wide variety of configurations and dimensions suitable for transporting a human as is typical for conventional bicycles, tricycles, quadricycles, wheelchairs, or the like, whereby the size can be tailored to accommodate an adult or a child, depending upon the embodiment.

As to particular embodiments, the inventive vehicle (1) can be a human-powered vehicle, which may be defined as a mode of transportation that relies on human effort, such as physical exertion of the rider, for propulsion. As to particular embodiments, the human-powered vehicle can rely entirely on human effort for propulsion. As to other particular embodiments, the human-powered vehicle can rely on human effort and be assisted by an electric motor or other machine which converts electrical energy into mechanical energy for propulsion, whereby conventional examples of such vehicles may include electric bicycles, electric tricycles, electric quadricycles, electric wheelchairs, or the like.

Regarding travel of the vehicle (1), to “drive” the vehicle (1) means to propel or to cause the vehicle (1) to move by force, such that the vehicle (1) can travel in a desired direction. To “steer” or “turn” the vehicle (1) means to cause the vehicle (1) to change its direction of travel to the right or to the left.

As used herein, the term “rotate” and its derivatives can mean to turn or cause to turn about an axis or a center point and/or to circle around an axis or a center point. As to particular embodiments, a synonym of “rotate” can be “pivot” or “turn” or “twist.” Directional terms used herein, such as front, rear, forward, rearward, down, up, downward, upward, right, left, etc. can be based on a human rider's frame of reference and presume a direction of travel of the vehicle (1) in the direction that the rider faces. “Front” and “forward” can mean generally the direction in which the rider faces, and “rear” and “rearward” can mean generally the opposite thereof. “Down” and “downward,” as well as “beneath” and below,” can mean generally toward the surface (5) on which the vehicle (1) travels, and “up” and “upward” and “above” can mean generally the opposite thereof. Additionally, “horizontal” can mean generally parallel to the surface (5) on which the vehicle (1) travels, and “vertical” can mean generally orthogonal (or perpendicular or normal) to the surface (5) on which the vehicle (1) travels.

Again referring primarily to FIGS. 1A through 2E, the structural frame (2), typically tubular, can borrow basic principles from the design of conventional bicycles, tricycles, quadricycles, wheelchairs, or the like. Correspondingly, the frame (2) can include a frame front end (6) opposite a frame rear end (7), a frame right side, and a frame left side, whereby the frame (2) can be generally symmetrical along its longitudinal axis (which extends between the frame front and rear ends (6) (7)), meaning that the frame right and left sides can each be a mirror image of the other. The frame (2) can be constructed from any appropriate material including, but not limited to, aluminum, titanium, steel, carbon fiber, or the like, or combinations thereof. Additionally, a seat (8) and/or backrest can be coupled to the frame (2) to support the rider in a sitting position when riding the vehicle (1).

At least two wheels can be rotatably coupled to the frame (2), whereby the wheels (typically including rubber tires) may be similar to wheels used for conventional bicycles, tricycles, quadricycles, wheelchairs, or the like, and attached to the frame (2) in a similar manner. As to particular embodiments, the inventive vehicle (1) can include (or can include only) two wheels and in particular, a front wheel (9) rotatably coupled to the frame (2) proximate the frame front end (6), and a rear wheel (10) rotatably coupled to the frame (2) proximate the frame rear end (7), whereby such embodiments may be configured as similar to a conventional bicycle. As to other particular embodiments, the inventive vehicle (1) can include (or can include only) three wheels and in particular, a front wheel (9) rotatably coupled to the frame (2) proximate the frame front end (6), and a pair of rear wheels (10) rotatably coupled to the frame (2) proximate the frame rear end (7) in horizontally spaced apart relation, whereby such embodiments may be configured as similar to a conventional tricycle having one front wheel and two rear wheels. As to other particular embodiments, the inventive vehicle (1) can include (or can include only) three wheels and in particular, a pair of front wheels (9) rotatably coupled to the frame (2) proximate the frame front end (6) in horizontally spaced apart relation, and a rear wheel (10) rotatably coupled to the frame (2) proximate the frame rear end (7), whereby such embodiments may be configured as similar to a conventional tricycle having two front wheels and one rear wheel. As to other particular embodiments, the inventive vehicle (1) can include (or can include only) four wheels and in particular, a pair of front wheels (9) rotatably coupled to the frame (2) proximate the frame front end (6) in horizontally spaced apart relation, and a pair of rear wheels (10) rotatably coupled to the frame (2) proximate the frame rear end (7) in horizontally spaced apart relation, whereby such embodiments may be configured as similar to a conventional quadricycle or wheelchair.

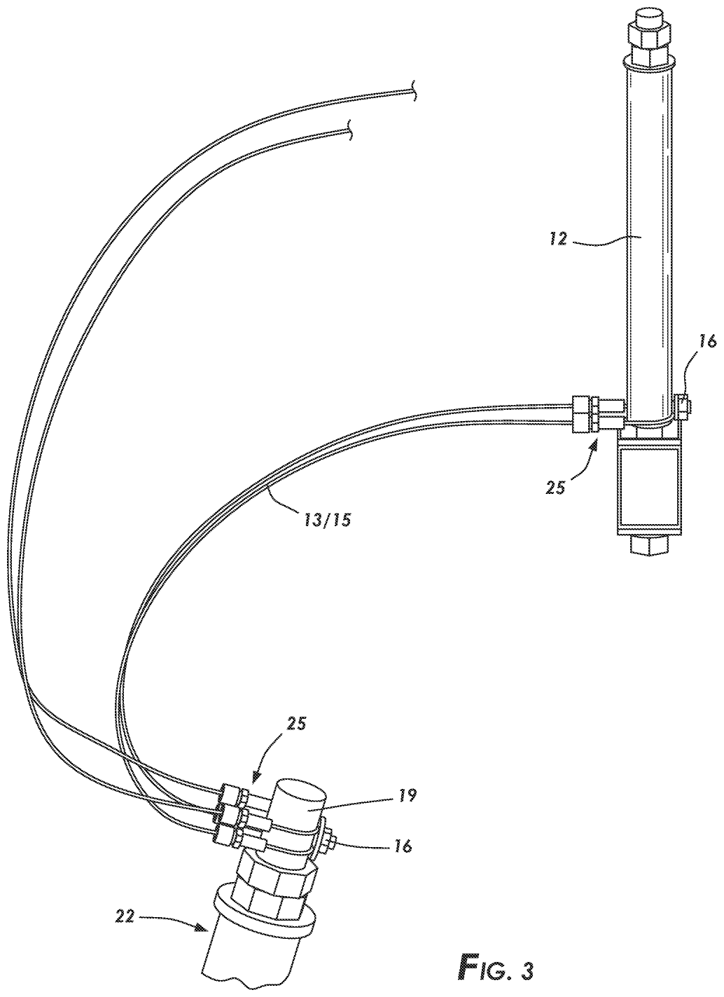

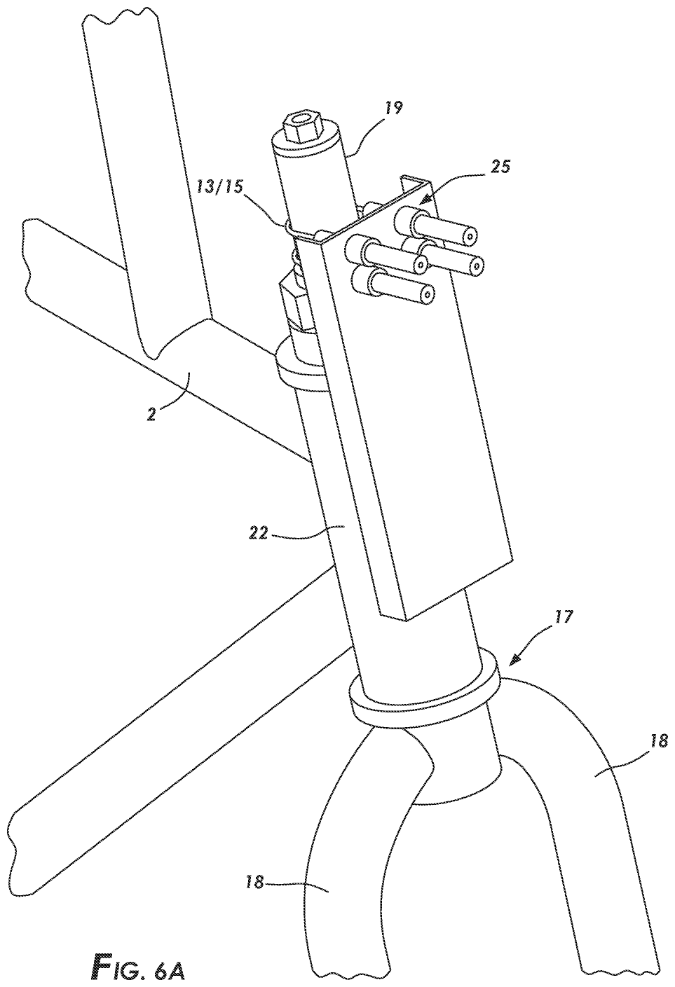

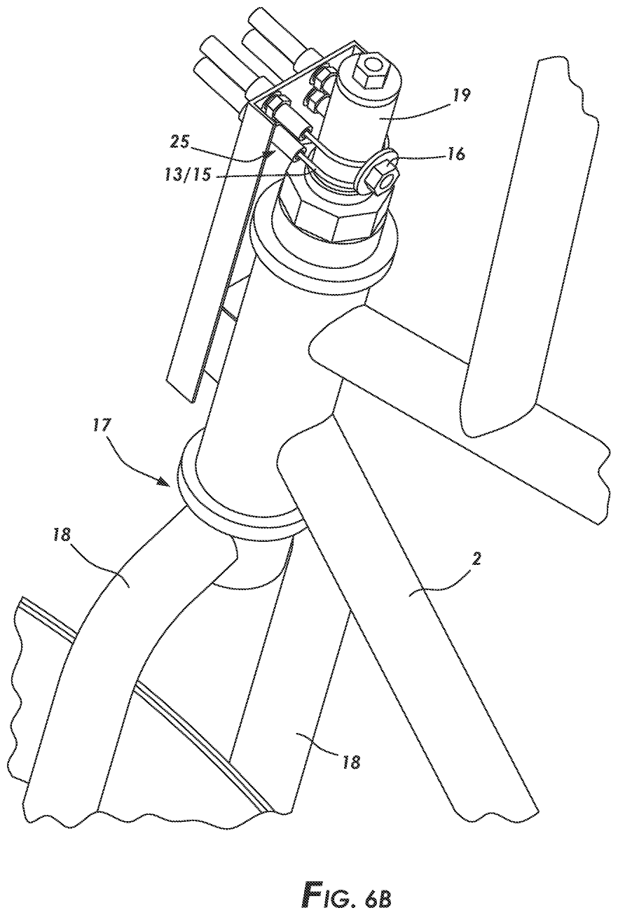

Now referring primarily to FIGS. 3 through 6B, the present invention can include a novel steering system for steering a steerable wheel (4) which may rotate about a steering axis (11) to steer the vehicle (1) (as shown in FIGS. 1A and 2A), such as to the right or to the left. For actuation, a steering handle (12) can be operably coupled to the steerable wheel (4) by a link (13); in operation, when the steering handle (12), which may be configured as an elongate member having a generally circular cross-section, is rotated about a steering actuation axis (14), the steerable wheel (4) correspondingly rotates about the steering axis (11), thereby steering the vehicle (1). In more detail, rotation of the steering handle (12) about the steering actuation axis (14) can pull the link (13) which forcibly urges the steerable wheel (4) to rotate about the steering axis (11), thereby steering the vehicle (1). In yet more detail, as to particular embodiments, depending upon the connections of the link (13), rotation of the steering handle (12) about the steering actuation axis (14) in a first direction (such as clockwise) can pull the link (13) in the first direction (such as clockwise) which forcibly urges the steerable wheel (4) to rotate about the steering axis (11) in the first direction (such as clockwise) to steer the vehicle (1) in the first direction (such as to the right). Alternatively, rotation of the steering handle (12) about the steering actuation axis (14) in a second direction (such as counterclockwise) can pull the link (13) in the second direction (such as counterclockwise) which forcibly urges the steerable wheel (4) to rotate about the steering axis (11) in the second direction (such as counterclockwise) to steer the vehicle (1) in the second direction (such as to the left).

As to other particular embodiments, depending upon the connections of the link (13), rotation of the steering handle (12) about the steering actuation axis (14) in the first direction (such as clockwise) can pull the link (13) in the first direction (such as clockwise) which forcibly urges the steerable wheel (4) to rotate about the steering axis (11) in the second direction (such as counterclockwise) to steer the vehicle (1) in the second direction (such as to the left), and rotation of the steering handle (12) about the steering actuation axis (14) in the second direction (such as counterclockwise) can pull the link (13) in the second direction (such as counterclockwise) which forcibly urges the steerable wheel (4) to rotate about the steering axis (11) in the first direction (such as clockwise) to steer the vehicle (1) in the first direction (such as to the right).

The link (13) can be any suitable flexible elongate member. As but one illustrative example, the link (13) can be configured as a flexible cable (15) or rope, such as a wire rope. As but another illustrative example, the link (13) can be configured as a flexible belt. As but another illustrative example, the link (13) can be configured as a flexible chain (which may function with a toothed connection). In the following description and in the Figures, the link (13) is described and shown as a flexible cable (15); however, as indicated above, the link (13) need not be limited to such a cable (15).

For the operable connection, the cable (15) can be fixedly engaged (whether directly or indirectly) with both the steering handle (12) and the steerable wheel (4), whereby as used herein, when two objects are “fixedly engaged” (or “rigidly engaged”) or “fixedly coupled” (or “rigidly coupled”) or “fixedly connected” (or “rigidly connected”), movement of one object invariably results in movement of the other object, usually in the same direction. The cable (15) can be fixedly engaged with the steering handle (12) and the steerable wheel (4) in any suitable manner. As but one illustrative example, the cable (15) can be fixedly engaged with the steering handle (12) and/or the steerable wheel (4) via a mechanical fastener, such as a set screw (16). As but another illustrative example, the cable (15) can be fixedly engaged with the steering handle (12) and/or the steerable wheel (4) via frictional wrapping.

Again referring primarily to FIGS. 3 through 6B, as to a specific embodiment, the cable (15) can (i) dispose about (or overlay) at least a portion of the perimeter (such as the circumference) of the steering handle (12) (such as about a lower portion thereof) and (ii) be fixedly connected thereto via a set screw (16). Additionally, the cable (15) can be fixedly coupled to the steerable wheel (4) via a fork (17) comprising a pair of legs (18) downwardly extending from a steerer tube (19). The steerable wheel (4) can be rotatably coupled between the legs (18), such as via a wheel axle (20), whereby a driving axis (21) about which the steerable wheel (4) rotates to drive the vehicle (1) may be defined by and/or pass through the wheel axle (20) and accordingly, the driving axis (21) can dispose in a generally horizontal orientation. The steerer tube (19) can be rotatably coupled to the frame (2), such as via insertion into a head tube (22) of the frame (2), whereby the steering axis (11) may be defined by and/or pass through the steerer tube (19). Thus, the steering axis (11) can dispose in an upright or generally vertical orientation; for example, as the fork (17) can typically be angled backwards (or rearwards), the steerer tube (19) shown in the Figures disposes in an upright orientation at an angle of about 75° relative to the driving axis (21).

As per the above, the fork (17) couples the steerable wheel (4) to the frame (2) such that the steerable wheel (4) can rotate relative to the frame (2) to steer the vehicle (1). For operation, the cable (15) can be fixedly connected to the fork (17). As to particular embodiments, the cable (15) can (i) dispose about (or overlay) at least a portion of the perimeter (such as the circumference) of the steerer tube (19) and (ii) be fixedly connected thereto via a set screw (16). Following, rotation of the steering handle (12) about the steering actuation axis (14) can pull the cable (15) disposed between the steering handle (12) and the steerer tube (19) to forcibly urge the fork (17) and correspondingly the steerable wheel (4) to rotate about the steering axis (11), thereby steering the vehicle (1). As to particular embodiments, the present steering system may be considered a pull/pull arrangement, as the cable (15) can pull the steerable wheel (4) both right and left in response to rotation of the steering handle (12) clockwise and counterclockwise, respectively.

Of note, it is herein contemplated that the perimeter (such as the circumference) of the portion of the steering handle (12) about which the cable (15) disposes could be selectively varied, such as made lesser or greater, relative to the perimeter (such as the circumference) of the portion of the fork (17) (for example, its steerer tube (19)) about which the cable (15) disposes to cause a given angular rotation of the steering handle (12) to produce a different angular rotation of the fork (17) and correspondingly the steerable wheel (4). By doing so, mechanical advantage between the steering handle (12) and the fork (17) and correspondingly the steerable wheel (4) can be manipulated as desired.

The steering handle (12) can be rotatable about the steering actuation axis (14) which may dispose in generally orthogonal relation to the driving axis (21) about which the steerable wheel (4) rotates to drive the vehicle (1). Additionally, as to particular embodiments, a steering handle longitudinal axis (23) which extends between opposing steering handle ends of the elongate member can be parallel to and/or coincident with the steering actuation axis (14). Thus, the steering handle (12), the steering handle longitudinal axis (23), and the steering actuation axis (14) can dispose in an upright or generally vertical orientation whereas, for reference, the driving axis (21) may dispose in a generally horizontal orientation. In contrast, a conventional bicycle may have handles with longitudinal axes which typically dispose in a generally horizontal orientation, such as on opposing ends of a handlebar.

As to particular embodiment, the present steering system can employ only one cable (15) per steering handle (12). Following, the cable (15) can have a cable middle portion disposed between opposing cable ends. As to particular embodiments, the cable middle portion can be disposed about and fixedly connected to the steering handle (12), and the cable ends can be disposed about and fixedly connected to the fork (17). As to other particular embodiments, the cable middle portion can be disposed about and fixedly connected to the fork (17), and the cable ends can be disposed about and fixedly connected to the steering handle (12).

As to particular embodiments, the cable (15) or a portion thereof can be disposed in a cable housing, such as a sheath or sleeve.

As to particular embodiments, the steering system can further include an adjuster (25) configured to adjust the tension and/or effective length of the cable (15). As but one illustrative example, a brake cable adjuster (or brake cable barrel adjuster) comprising an adjustment screw and a fixed nut, can act as such an adjuster (25).

As to particular embodiments, the steering system can further include a grip (26) fixedly coupled to the steering handle (12) to facilitate the gripping thereof, whereby the grip (26), made from a suitable grippable material, may be disposed about or surround or enclose the steering handle (12). As to particular embodiments, the grip (26) can include a laterally outwardly extending protrusion (27) which may be engageable with the hand of the rider of the vehicle (1) to facilitate gripping of the grip (26) and correspondingly the steering handle (12). As to particular embodiments, the protrusion (27) can be arcuate and may have a semi-circular cross section, although other configurations may be herein contemplated.

As to particular embodiments, the steering system can further include a hand rest (28) disposed beneath or below the steering handle (12) to allow the rider's hand to rest thereon while engaging with the steering handle (12).

Regarding the present steering system, while a vehicle (1) configured similar to a bicycle, tricycle, quadricycle, wheelchair, or the like, can include two of the inventive steering handles (12), such as one per hand, as to particular embodiments, it may be sufficient to rotate only one of the two steering handles (12) to steer the vehicle (1), as each steering handle (12) can steer the steerable wheel (4) to the right or to the left. Accordingly, each steering handle (12) can operate independently from the other steering handle (12) to steer the steerable wheel (4). Thus, steering the vehicle (1) can be done by turning either of the two steering handles (12) about its steering actuation axis (14), or both of the steering handles (12) about their steering actuation axes (14).

As to particular embodiments, the present steering system can operably consist of the steering handle (12) rotatable about the steering actuation axis (14), the fork (17) rotatable relative to the frame (2), and the cable (15) fixedly coupled to the steering handle (12) and the fork (17) to communicate therebetween, whereby a steerable wheel (4) coupled to the fork (17) may be responsive to rotation of the steering handle (12) to steer the vehicle (1).

Now referring primarily to FIGS. 1A through 2E, the present invention can include an inventive driving system comprising a drivable wheel (3) rotatably coupled to the frame (2), such as via a fixed connection to a wheel axle (20) rotatably connected to the frame (2), whereby the wheel axle (20) and correspondingly the drivable wheel (3) may rotate about the driving axis (21) to drive the vehicle (1). As indicated above, the driving axis (21) can be defined by and/or pass through the wheel axle (20) and accordingly, the driving axis (21) may dispose in a generally horizontal orientation.

A crank axle (29) can drive rotation of the wheel axle (20) and correspondingly the drivable wheel (3). Following, a crank sprocket (30) (fixedly coupled or connected to the crank axle (29)), a wheel axle sprocket (31) (fixedly coupled or connected to the wheel axle (20)), and a chain (32) (or similar link) can dispose between the crank axle (29) and the wheel axle (20) to communicate therebetween. The chain (32) can be disposed about the crank sprocket (30) and the wheel axle sprocket (31) to operably connect the two. In operation, rotation of the crank axle (29) about a driving actuation axis (33) can drive rotation of the fixedly coupled crank sprocket (30) about the driving actuation axis (33). Rotation of the crank sprocket (30) about the driving actuation axis (33) can drive travel of the chain (32) disposed thereabout, whereby travel of the chain (32) can drive rotation of the wheel axle sprocket (31) about the driving axis (21). Rotation of the wheel axle sprocket (31) about the driving axis (21) can drive rotation of the fixedly coupled wheel axle (20) and correspondingly the drivable wheel (3) about the driving axis (21) to drive the vehicle (1). Akin to the driving axis (21), the crank axle (29) and the driving actuation axis (33) can dispose in a generally horizontal orientation.

Rotation of the crank axle (29) can be driven by rotation of a crank arm (34) fixedly coupled or connected thereto about the driving actuation axis (33). Typically, the crank arm (34) can have a crank arm longitudinal axis (35) which extends between opposing crank arm first and second ends (36) (37). The crank arm first end (36) can be fixedly coupled or connected to the crank axle (29) to drive rotation thereof about the driving actuation axis (33).

Rotation of the crank arm (34) about the driving actuation axis (33) can be driven by a driving actuator (38) coupled thereto. Specifically, the driving actuator (38) can be coupled to the crank arm second end (37). As to particular embodiments, the driving actuator (38) can be rotatably coupled to the crank arm second end (37) such that the driving actuator (38) can rotate about a driving actuator rotation axis (39) which may be defined by and/or pass through the crank arm second end (37) and thus, may dispose in generally orthogonal relation to the crank arm longitudinal axis (35). Correspondingly, the driving actuator rotation axis (39) can dispose in a generally horizontal orientation.

As to particular embodiments, the driving actuator (38), which may be engaged by the rider's foot or hand depending upon the embodiment, can be rotatably coupled to the crank arm (34) to allow the rider's foot or hand to move in a circular motion during rotation of the crank arm (34) and correspondingly, the crank axle (29), about the driving actuation axis (33) for a smoother and more efficient rotating motion and thus, a more effective transfer of power from the rider to the drivable wheel (3) of the vehicle (1).

Of note, the length of the crank arm (34), the configuration of the driving actuator (38), and the ratio of the circumference of the crank sprocket (30) to the circumference of the wheel axle sprocket (31) can vary, depending upon the embodiment and its particular application.

As alluded to above, as to particular embodiments, the driving actuator (38) can comprise a driving pedal (40), such as a manual or foot-operated pedal. Accordingly, the rider's feet (as well as legs and lower body) can drive rotation of the crank arm (34) about the driving actuation axis (33) which drives rotation of the crank axle (29) about the driving actuation axis (33) which drives rotation of the crank sprocket (30) about the driving actuation axis (33). Rotation of the crank sprocket (30) drives travel of the chain (32) disposed thereabout to drive rotation of the wheel axle sprocket (31) about which the chain (32) also disposes. Rotation of the wheel axle sprocket (31) about the driving axis (21) can drive rotation of the wheel axle (20) and correspondingly the drivable wheel (3) about the driving axis (21) to drive the vehicle (1).

As to particular embodiments, the driving pedal (40) and its corresponding crank assembly can dispose beneath or below the seat (8), as shown in FIGS. 1A through 1E and 2A through 2E. As to particular embodiments, the driving pedal (40) and its corresponding crank assembly can dispose in front of the seat (8), as shown in FIGS. 1A through 1E.

As also alluded to above, as to other particular embodiments, the driving actuator (38) can comprise a driving handle (41), such as a manual or hand-operated driving handle (41). Accordingly, the rider's hands (as well as arms and upper body) can drive rotation of the crank arm (34) about the driving actuation axis (33) which drives rotation of the crank axle (29) about the driving actuation axis (33) which drives rotation of the crank sprocket (30) about the driving actuation axis (33). Rotation of the crank sprocket (30) drives travel of the chain (32) disposed thereabout to drive rotation of the wheel axle sprocket (31) about which the chain (32) also disposes. Rotation of the wheel axle sprocket (31) about the driving axis (21) can drive rotation of the wheel axle (20) and correspondingly the drivable wheel (3) about the driving axis (21) to drive the vehicle (1).

As to particular embodiments, the driving handle (41) and its corresponding crank assembly can dispose above and in front of the seat (8), as shown in FIGS. 1A through 2E.

Regarding the driving handle (41) and its crank assembly, as to particular embodiments, the inventive vehicle (1) can include one crank sprocket (30) per drivable wheel (3) (as shown in FIGS. 1A through 1E and 2A through 2E). As to particular embodiments, the inventive vehicle (1) can include one driving handle (41) per crank sprocket (30), as shown in FIGS. 1A through 1E. As to particular embodiments, the driving handle (41) can be proximate one end of the crank axle (29) and the crank sprocket (30) can be proximate the opposing end of the crank axle (29). As an illustrative example, an inventive vehicle (1) having two drivable wheels (3) in horizontally spaced apart relation, such as right and left drivable wheels (3), can include a right driving handle (41) and its crank assembly for driving the right drivable wheel (3) and a left driving handle (41) and its crank assembly for driving the left drivable wheel (3).

As to other particular embodiments, the inventive vehicle (1) can include two driving handles (41) per crank sprocket (30), as shown in FIGS. 2A through 2E. As to particular embodiments, one driving handle (41) can be proximate one end of the crank axle (29) and the other driving handle (41) can be proximate the opposing end of the crank axle (29). As an illustrative example, an inventive vehicle (1) having one drivable wheel (3) can include a right driving handle (41) and a left driving handle (41), both coupled to the crank axle (29) which operably communicates with the wheel axle (20) to drive the drivable wheel (3).

In both of the above embodiments, it can be sufficient to rotate only one of the driving handles (41) to drive the vehicle (1), as each driving handle (41) can independently drive one drivable wheel (3) (as shown in FIGS. 2A through 2E) or two drivable wheels (3) (as shown in FIGS. 1A through 1E). Thus, driving the vehicle (1) can be done by rotating either of the two driving handles (41) about its driving actuation axis (33), or both of the driving handles (41) about their driving actuation axes (33).

As to particular embodiments, the inventive vehicle (1) can include and be driven via both a driving pedal (40) (which may be a first driving actuator (42)) and a driving handle (41) (which may be a second driving actuator (43)).

Now referring primarily to FIGS. 1A through 2E, as to particular embodiments, the driving pedal (40)/first driving actuator (42) can drive rotation of the pedal's crank sprocket (44) which directly communicates with the wheel axle sprocket (31) to drive the drivable wheel (3) about the driving axis (21) to drive the vehicle (1). Correspondingly, one pedal chain (45) can dispose between the pedal's crank sprocket (44) and the wheel axle sprocket (31). In operation, the driving pedal (40) can drive rotation of the pedal's crank arm (46), the pedal's crank axle (47), and the pedal's crank sprocket (44) about the pedal's driving actuation axis (48). Rotation of the pedal's crank sprocket (44) drives travel of the pedal chain (45) disposed thereabout to drive rotation of the wheel axle sprocket (31) about which the pedal chain (45) also disposes. Rotation of the wheel axle sprocket (31) about the driving axis (21) can drive rotation of the wheel axle (20) and correspondingly the drivable wheel (3) about the driving axis (21) to drive the vehicle (1).

Now referring primarily to FIGS. 1A through 1E, as to particular embodiments, the driving handle (41)/second driving actuator (43) can drive rotation of the handle's crank sprocket (49) which directly communicates with the wheel axle sprocket (31) to drive the drivable wheel (3) about the driving axis (21) to drive the vehicle (1). Correspondingly, one handle chain (50) can dispose between the handle's crank sprocket (49) and the wheel axle sprocket (31). In operation, the driving handle (41) can drive rotation of the handle's crank arm (51), the handle's crank axle (52), and the handle's crank sprocket (49) about the handle's driving actuation axis (53). Rotation of the handle's crank sprocket (49) drives travel of the handle chain (50) disposed thereabout to drive rotation of the wheel axle sprocket (31) about which the handle chain (50) also disposes. Rotation of the wheel axle sprocket (31) about the driving axis (21) can drive rotation of the wheel axle (20) and correspondingly the drivable wheel (3) about the driving axis (21) to drive the vehicle (1).

Now referring primarily to FIGS. 2A through 2E, as to other particular embodiments, the driving handle (41)/second driving actuator (43) can drive rotation of the handle's crank sprocket (49) which indirectly communicates with the wheel axle sprocket (31) via an intermediate sprocket (54) to drive the drivable wheel (3) about the driving axis (21) to drive the vehicle (1). Correspondingly, a handle chain (50) can operably dispose between the handle's crank sprocket (49) and the intermediate sprocket (54) which can be fixedly coupled or connected to the pedal's crank axle (47), and a pedal chain (45) can operably dispose between the pedal's crank sprocket (44) and the wheel axle sprocket (31). In operation, the driving handle (41) can drive rotation of the handle's crank arm (51), the handle's crank axle (52), and the handle's crank sprocket (49) about the handle's driving actuation axis (53). Rotation of the handle's crank sprocket (49) drives travel of the handle chain (50) disposed thereabout to drive rotation of the intermediate sprocket (54) about which the handle chain (50) also disposes. Rotation of the intermediate sprocket (54) drives rotation of the pedal's crank sprocket (44) about the pedal's driving actuation axis (48). Rotation of the pedal's crank sprocket (44) drives travel of the pedal chain (45) disposed thereabout to drive rotation of the wheel axle sprocket (31) about which the pedal chain (45) also disposes. Rotation of the wheel axle sprocket (31) about the driving axis (21) can drive rotation of the wheel axle (20) and correspondingly the drivable wheel (3) about the driving axis (21) to drive the vehicle (1).

As to particular embodiments, as shown in the examples of the Figures, the steering handle (12) and the driving handle (41) can be configured as the same handle, which may thus be a dual-purpose handle (55) able to both steer and drive the vehicle (1). As to these particular embodiments, the vehicle (1) can include (i) only one dual-purpose handle (55) which can both steer and drive the vehicle (1), or (ii) only one pair of dual-purpose handles (55), each of which can both steer and drive the vehicle (1).

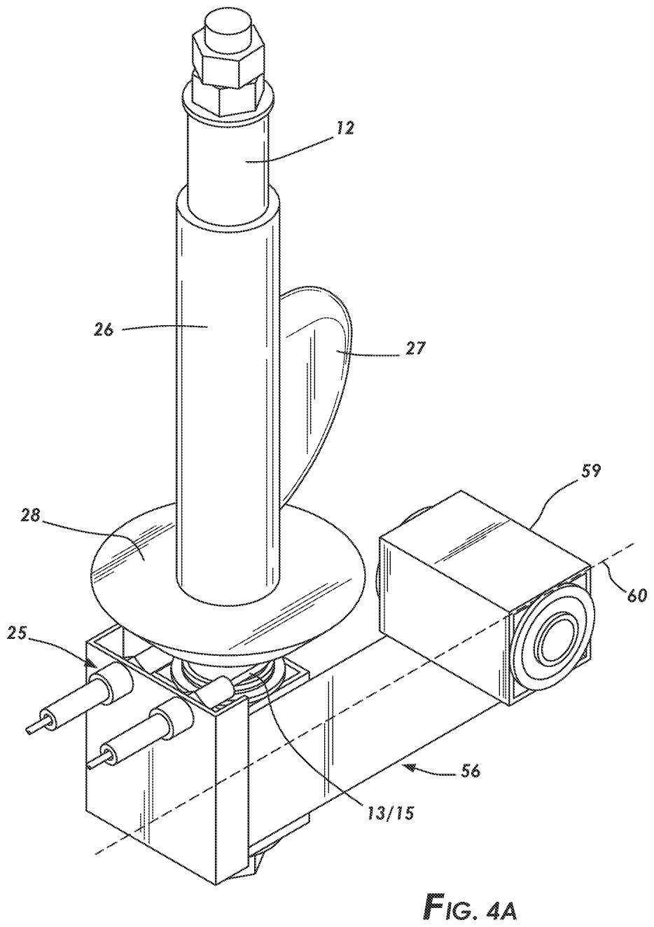

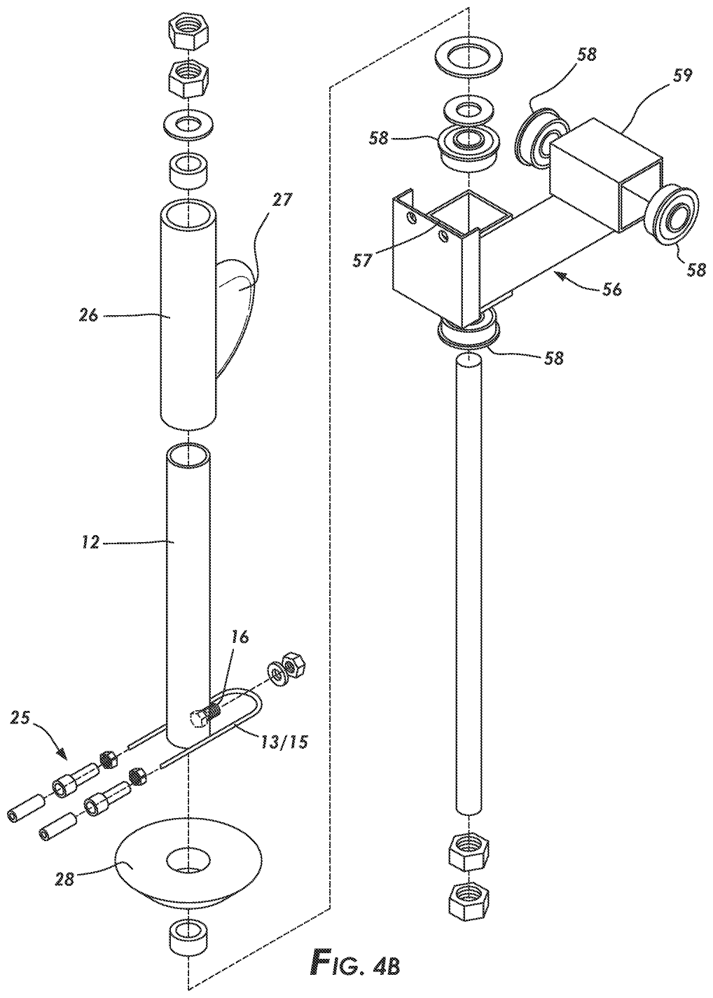

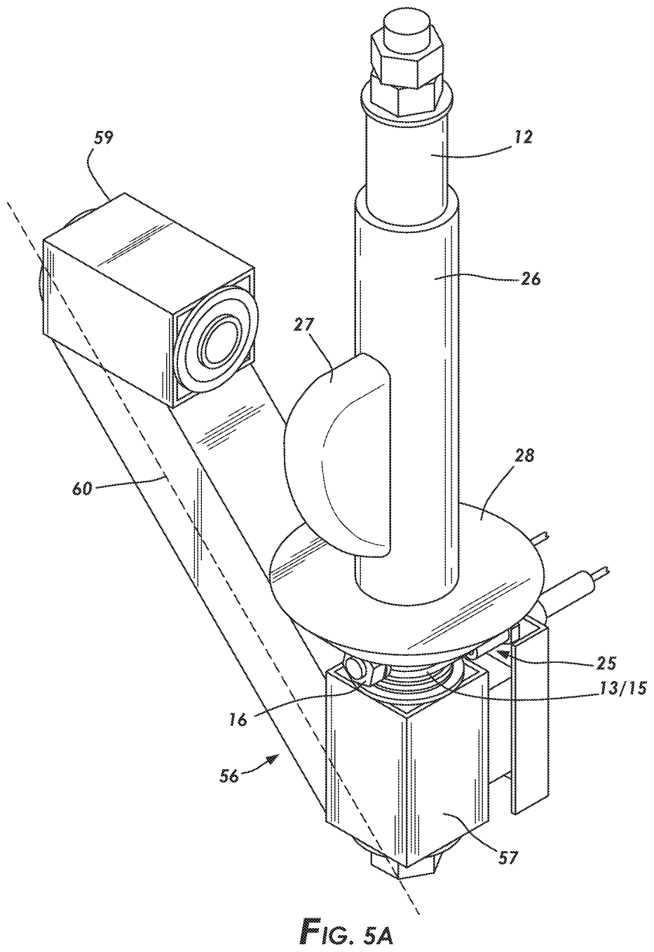

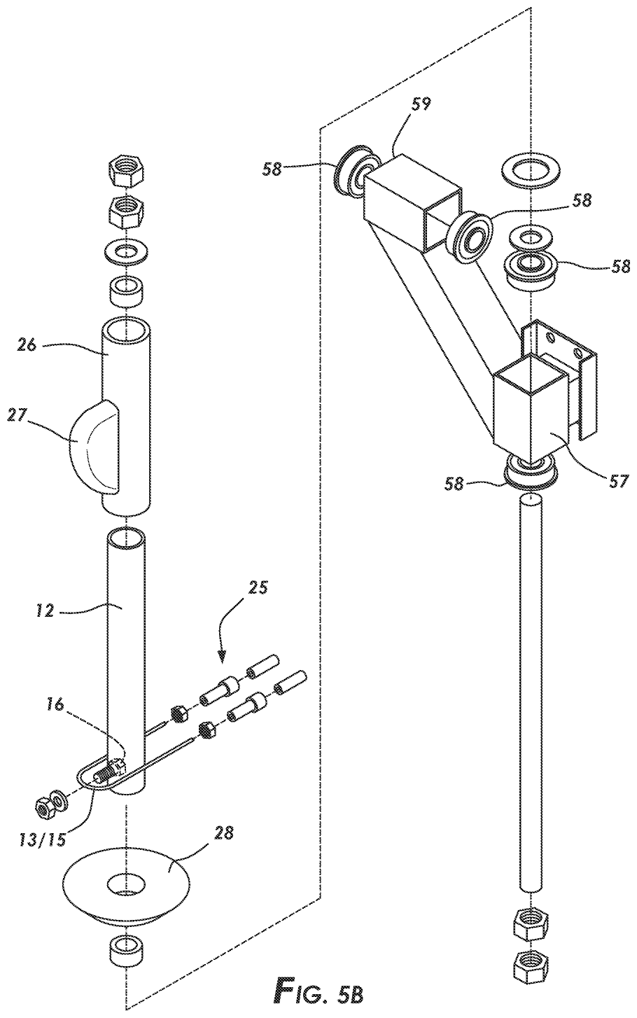

Now referring primarily to FIGS. 4A through 5B, the dual-purpose handle (55) can be rotatably coupled to the crank arm (34), such as to the crank arm second end (37), via a coupler (56) disposed therebetween, whereby the coupler (56) may be configured as an elongate member. As to particular embodiments, the dual-purpose handle (55) can be rotatably coupled to the coupler (56) proximate a coupler first end (57), such as via one or more ball bearings (58), to allow the dual-purpose handle (55) to rotate about the steering actuation axis (14). Additionally, the coupler (56) can be rotatably coupled to the crank arm second end (37) proximate a coupler second end (59), such as via one or more ball bearings (58), to allow the dual-purpose handle (55) to rotate about the driving actuator rotation axis (39).

As to particular embodiments, the dual-purpose handle (55) can be rotatably coupled to the coupler (56) proximate a lower portion of the dual-purpose handle (55), which may thus dispose the coupler first end (57) beneath or below the dual-purpose handle (55). Now referring primarily to FIGS. 4A and 4B, as to particular embodiments, a coupler longitudinal axis (60) which extends between the coupler first and second ends (57) (59) can be in generally orthogonal relation to the dual-purpose handle longitudinal axis (23). Now referring primarily to FIGS. 5A and 5B, as to other particular embodiments, the coupler longitudinal axis (60) can be in angled relation to the dual-purpose handle longitudinal axis (23). As to particular embodiments, the angle between the coupler longitudinal axis (60) and the dual-purpose handle longitudinal axis (23) can be acute; for example, the angle between the coupler longitudinal axis (60) and the dual-purpose handle longitudinal axis (23) can be about 45°.

As to particular embodiments, the inventive vehicle (1) can further include a brake system for braking or slowing or stopping the vehicle (1). As to particular embodiments, the brake system, its arrangement, and its operation can be similar to brake systems known in the art; accordingly, a detailed discussion thereof is omitted. Of note, the brake type can depend on factors like the type of vehicle, style of riding, personal preference, riding conditions, and/or maintenance considerations. As nonlimiting examples, the brake system can include rim brakes (such as caliper brakes or cantilever brakes), disc brakes (such as mechanical disc brakes or hydraulic disc brakes), coaster brakes, drum brakes, band brakes, roller brakes, and hybrid brakes (which can be a combination of different brake types, such as a hydraulic disc brake in the front and a mechanical disc brake in the rear).

As to particular embodiments, the brakes can be activated by hand levers, which may be adjacent to, coupled to, connected to, or integrated with a handle (12) (41) (55).

As to particular embodiments, the inventive vehicle (1) can further include a gear system which provides different gears, typically via a shift mechanism (which may include a hand lever and cable(s)). As to particular embodiments, the gear system, its arrangement, and its operation can be similar to gear systems known in the art; accordingly, a detailed discussion thereof is omitted.

As to particular embodiments, the shift mechanism can be activated by a hand lever, which may be adjacent to, coupled to, connected to, or integrated with a handle (12) (41) (55).

To make a particular embodiment of the inventive steering system, the inventive driving system, or the inventive vehicle (1), the method can include coupling together one or more components described above.

To use a particular embodiment of the inventive steering system, the method can include steering a vehicle (1) to which said steering system is operably coupled.

To use a particular embodiment of the inventive driving system, the method can include driving a vehicle (1) to which said driving system is operably coupled.

To use a particular embodiment of the inventive vehicle, the method can include steering a vehicle (1) which comprises the inventive steering system and/or driving a vehicle (1) which includes the inventive driving system.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods, and apparatus have been described herein for the purpose of illustration. These are only examples. The technology provided herein can be applied to systems other than the example systems described above. Many alterations, modifications, additions, omissions, and permutations are possible within the practice of this invention. This invention includes variations on described embodiments that would be apparent to a person of ordinary skill in the art, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “particular embodiments.” Such features are not mandatory and may not be present in all embodiments. Embodiments of the invention may include zero, any one, or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “particular embodiments” possess feature A and “particular embodiments” possess feature B should be interpreted as an express indication that the inventors also contemplate embodiments which combine features A and B (unless the description states otherwise or features A and B are fundamentally incompatible).

As can be easily understood from the foregoing, the basic concepts of the present invention may be embodied in a variety of ways. The invention involves numerous and varied embodiments of a steering system and a driving system for a human-powered vehicle.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “driver” should be understood to encompass disclosure of the act of “driving”—whether explicitly discussed or not—and, conversely, were there effectively disclosure of the act of “driving,” such a disclosure should be understood to encompass disclosure of a “driver” and even a “means for driving.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the systems and methods for a steering system and a driving system for a human-powered vehicle herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A human-powered vehicle, comprising:
a frame;
a drivable wheel coupled to said frame;
a steerable wheel coupled to said frame; and
a steering handle operably coupled to said steerable wheel via a link;
wherein rotation of said steering handle about a steering actuation axis correspondingly rotates said steerable wheel about a steering axis to steer said vehicle.

2-5. (canceled)

6. The vehicle of claim 1, wherein said link comprises a flexible elongate member.

7-15. (canceled)

16. The vehicle of claim 1, wherein said steering actuation axis disposes in generally orthogonal relation to a driving axis about which said steerable wheel rotates to drive said vehicle.

17. The vehicle of claim 16, wherein a steering handle longitudinal axis of said steering handle and said steering actuation axis dispose in an upright or generally vertical orientation; and
wherein said driving axis disposes in a generally horizontal orientation.

18-20. (canceled)

21. The vehicle of claim 1, wherein said drivable wheel is rotatably coupled to said frame via a wheel axle; and
wherein said wheel axle and said drivable wheel rotate about a driving axis to drive said vehicle.

22. (canceled)

23. The vehicle of claim 21, further comprising a crank axle which drives rotation of said wheel axle.

24. The vehicle of claim 23, wherein said crank axle is rotatable about a driving actuation axis.

25. (canceled)

26. The vehicle of claim 24, further comprising a chain disposed between said crank axle and said wheel axle to communicate therebetween.

27. The vehicle of claim 26, further comprising:
a crank sprocket fixedly coupled to said crank axle; and
a wheel axle sprocket fixedly coupled to said wheel axle;
wherein said chain disposes about said crank sprocket and said wheel axle sprocket.

28-29. (canceled)

30. The vehicle of claim 27, further comprising a crank arm which drives rotation of said crank axle;
wherein a crank arm first end of said crank arm is fixedly coupled to said crank axle.

31. The vehicle of claim 30, further comprising a driving actuator which drives rotation of said crank arm.

32. The vehicle of claim 31, wherein said driving actuator is coupled to a crank arm second end of said crank arm.

33. The vehicle of claim 32, wherein said driving actuator is rotatably coupled to said crank arm second end to rotate about a driving actuator rotation axis.

34. (canceled)

35. The vehicle of claim 33, wherein said driving actuator comprises a foot-operated pedal.

36. The vehicle of claim 33, wherein said driving actuator comprises a hand-operated driving handle.

37. The vehicle of claim 36, wherein said vehicle has one said driving handle per one said crank sprocket.

38. The vehicle of claim 36, wherein said vehicle has two said driving handles per one said crank sprocket.

39-41. (canceled)

42. The vehicle of claim 36, wherein said steering handle and said driving handle are the same handle which functions as a dual-purpose handle.

43-52. (canceled)

53. A steering system for a vehicle, comprising:
a steering handle rotatable about a steering actuation axis;
a fork rotatable relative to a frame of said vehicle about a steering axis; and
a cable fixedly coupled to said steering handle and said fork to communicate therebetween;
wherein rotation of said steering handle about said steering actuation axis correspondingly rotates a steerable wheel coupled to said fork about a steering axis to steer said vehicle.

54. (canceled)

55. A steering system for a vehicle, operably consisting of:
a steering handle rotatable about a steering actuation axis;
a fork rotatable relative to a frame of said vehicle about a steering axis; and
a cable fixedly coupled to said steering handle and said fork to communicate therebetween;
wherein rotation of said steering handle about said steering actuation axis correspondingly rotates a steerable wheel coupled to said fork about a steering axis to steer said vehicle.
